(19) United States
(12) Patent Application Publication
(10) Pub. No.: US 2008/0002059 A1
(43) Pub. Date: Jan. 3, 2008

(54) Digital TV capture unit, information processing apparatus, and signal transmission method

(76) Inventors: Mitsuhiko Obara, Chiba-shi (JP); Makoto Midorikawa, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/823,604

(22) Filed: Jun. 28, 2007

(30) Foreign Application Priority Data
Jun. 28, 2006 (JP) 2006-178491

(51) Int. Cl. H04N 7/00

(52) U.S. Cl. 348/552

(57) ABSTRACT

According to one embodiment, there is provided a digital TV capture unit electrically connectable to a system bus of a computer. The unit includes a signal processing circuit which receives both a first output signal output from the first digital TV tuner module and a second output signal output from the second digital TV tuner module, and performs signal processing including descrambling, a bus interface circuit which performs control of transmitting a signal processed by the signal processing circuit, and an arbitration circuit which controls signal output operations of the first digital TV tuner module and the second digital TV tuner module to assure that the first output signal and the second output signal are alternately transmitted to the signal processing circuit in synchronism with a predetermined clock in units of packets.

### CROSS-REFERENCE TO RELATED APPLICATIONS

This application is based upon and claims the benefit of priority from Japanese Patent Application No. 2006-178491, filed Jun. 28, 2006, the entire contents of which are incorporated herein by reference.

### BACKGROUND

1. Field

One embodiment of the invention relates to a digital TV capture unit, an information processing apparatus, and a signal transmission method, which allow reception of a digital television broadcast signal.

2. Description of the Related Art

In recent years, attention has increasingly been given to digital television broadcast. Studies have been carried out to develop TV tuners mounted on personal computers (PCs) adapted to digital broadcasting, as well as TV receivers or recorders for the same purpose. Further, a unit containing two TV tuners has been in high demand.

Various types of unit containing two TV tuners have been proposed. For example, Jpn. Pat. Appln. KOKAI Publication No. 2003-347948 discloses a digital broadcast receiver comprising two systems, each including a tuner circuit and a demodulator circuit, and a signal processing circuit which processes the signals output from the two demodulator circuits.

However, if the conventional signal processing circuit as disclosed in the above publication receives signals from the demodulator circuits of the two systems, it need to process the signals simultaneously. Therefore, it substantially requires a circuit configuration for two systems of processing signals. Such a configuration hinders reduction in size, power consumption and cost of the apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a state in which a display unit of a computer according to an embodiment of the present invention is opened;

FIG. 2 is an exemplary diagram showing a system configuration of the computer;

FIG. 3 is an exemplary block diagram showing an example of a hardware configuration of a digital TV capture unit shown in FIG. 1;

FIG. 4 is an exemplary diagram showing a state in which a packet of a TS1 signal and a packet of a TS2 signal are alternately transmitted;

FIG. 5 is an exemplary block diagram showing a modification of a configuration of a digital TV capture unit shown in FIG. 3; and

FIG. 6 is an exemplary timing chart showing an operation of an arbitration circuit of the embodiment.

### DETAILED DESCRIPTION

Various embodiments according to the invention will be described hereinafter with reference to the accompanying drawings. In general, according to one embodiment of the invention, there is provided a digital TV capture unit electrically connectable to a system bus of a computer. The unit includes a first digital TV tuner module which receives a digital television broadcast signal and performs channel selection and signal demodulation, a second digital TV tuner module which receives a digital television broadcast signal and performs channel selection and signal demodulation, a signal processing circuit which receives both a first output signal output from the first digital TV tuner module and a second output signal output from the second digital TV tuner module, and performs signal processing including descrambling, a bus interface circuit which performs control of transmitting a signal processed by the signal processing circuit, and an arbitration circuit which controls signal output operations of the first digital TV tuner module and the second digital TV tuner module to assure that the first output signal and the second output signal are alternately transmitted to the signal processing circuit in synchronism with a predetermined clock in units of packets.

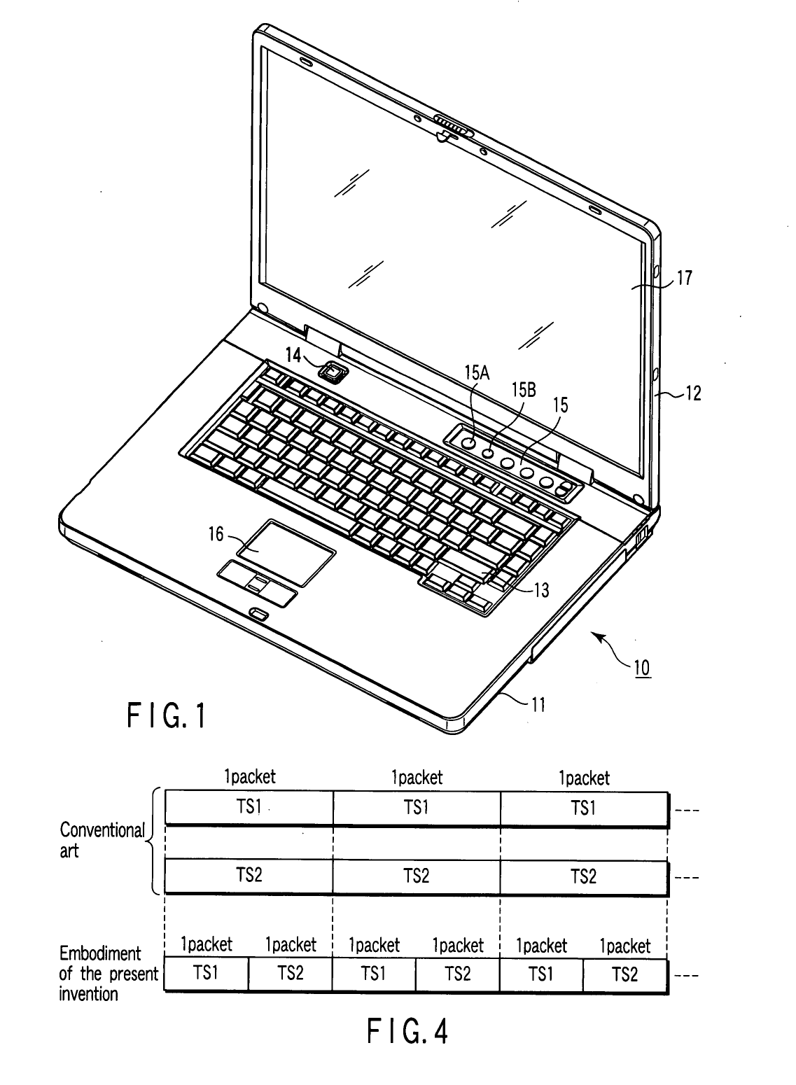

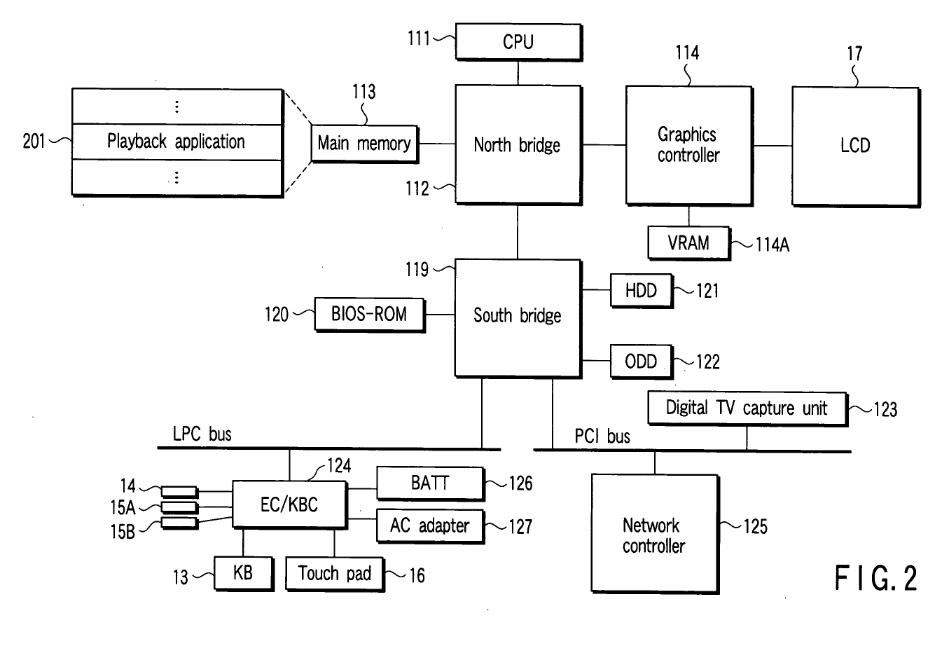

First, a configuration of an information processing apparatus according to the embodiment of the present invention will be described with reference to FIGS. 1 and 2. The information processing apparatus is implemented as, for example, a notebook computer 10.

FIG. 1 is a perspective view showing a state in which a display unit of the notebook computer 10 is opened. The computer 10 includes a computer main body 11 and a display unit 12. The display unit 12 incorporates a display device including a thin film transistor liquid crystal display (TFT-LCD) 17. The display screen of the LCD 17 is located substantially in the central portion of the display unit 12.

The display unit 12 is attached to the computer main body 11 so as to be rotatable between an open position and a closed position. The computer main body 11 has a thin box-shaped casing. The computer main body 11 includes a keyboard 13, a power button 14 to power on/off the computer 10, an input operation panel 15, a touch pad 16, etc., which are arranged on an upper surface of the casing.

The input operation panel 15 is an input device, through which an event corresponding to a depressed button is input. It has a group of buttons to activate a plurality of functions, respectively. The group of buttons includes a TV activating button 15A and a DVD/CD activating button 15B. The TV activating button 15A is a button to activate a TV function in order to play back, view, listen to and record TV broadcast program data. When the user depresses the TV activating button 15A, a TV playback application to perform the TV function is automatically activated. The DVD/CD activating button 15B is a button to play back video contents recorded in a DVD or CD. When the user depresses the DVD/CD activating button 15B, a video playback application to playback the video contents is automatically activated.

A system configuration of the computer 10 will now be described with reference to FIG. 2.

As shown in FIG. 2, the computer 10 includes a CPU 111, a north bridge 112, a main memory 113, a graphics controller 114, a south bridge 119, a BIOS-ROM 120, a hard disk drive (HDD) 121, an optical disk drive (ODD) 122, a digital TV capture unit 123, an embedded controller/keyboard controller IC (EC/KBC) 124, a network controller 125, etc.

The CPU 111 is a processor provided to control operations of the computer 10. It executes an operating system (OS) and various application programs, such as a playback application 201, loaded from the hard disk drive (HDD) 121 to a main memory 113.

The playback application 201 has a function of performing a process (including a decode process in compliance with MPEG2) of playing back a moving picture stream transmitted from the digital TV capture unit 123 via a PCI bus by means of the display device or the like. It also has a function of decoding and playing back moving picture contents, such as a digital TV broadcast program (encoded by an encoding method defined by, for example, H.264/AVC standard), which is recorded on the HDD 121 or ODD 122.

The CPU 111 executes a basic input output system (BIOS) stored in the BIOS-ROM 120. The BIOS is a program for controlling hardware.

The north bridge 112 is a bridge device which connects the south bridge 119 with a local bus of the CPU 111. The north bridge 112 incorporates a memory controller which controls access to the main memory 113. Further, the north bridge 112 has a function for executing communications with the graphics controller 114 via an AGP (Accelerated Graphics Port) bus or the like.

The graphics controller 114 is a display controller, which controls an LCD 17 used as a display monitor of the computer 10. The graphics controller 114 displays video data written in a video memory (VRAM) 114A on the LCD 17.

The south bridge 119 controls devices on a low pin count (LPC) bus and devices on a peripheral component interconnect (PCI) bus. The south bridge 119 incorporates an integrated drive electronics (IDE) controller to control the HDD 121 and ODD 122. Further, the south bridge 119 has a function for controlling the TV tuner 123 and a function for controlling access to the BIOS-ROM 120.

The HDD 121 is a storage device which stores various software and data. The optical disk drive (ODD) 122 is a drive unit to drive memory media, such as DVDs and CDs, which store video contents. The digital TV capture unit 123 includes a receiver (tuner) to externally receive TV broadcast program data.

The embedded controller/keyboard controller IC (EC/KBC) 124 is a one-chip microcomputer, in which an embedded controller to manage power and a keyboard controller to control the keyboard (KB) 13 and the touch pad 16 are integrated. The embedded controller/keyboard controller IC (EC/KBC) 124 has a function of powering on or off the computer 10 in accordance with the operation of the power button by the user. The power supplied to the respective components of the computer 10 are generated by the battery 126 incorporated in the computer 10, or an external power source and supplied through the AC adapter 127.

Further, the embedded controller/keyboard controller IC (EC/KBC) 124 can also power on the computer 10 in accordance with the operation of the TV activating button 15A or the DVDE/CD activating button 15B by the user. The network controller 125 is a communication apparatus, which performs communication with an external network, for example, the Internet.

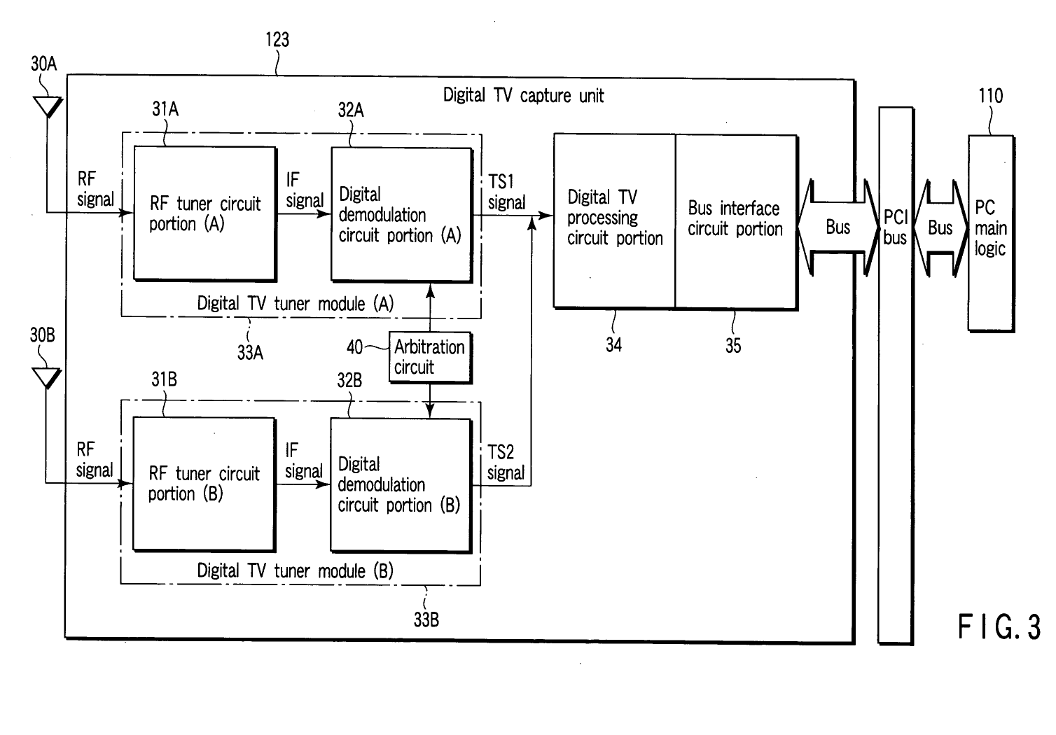

FIG. 3 is a block diagram showing an example of a hardware configuration of the digital TV capture unit 123 shown in FIG. 1.

The digital TV capture unit 123 is a board-like unit electrically connectable to the PCI bus (system bus). The digital TV capture unit 123 may be detachably or fixedly connected to the PCI bus.

The digital TV capture unit 123 includes a digital TV tuner module (A) 33A, a digital tuner module (B) 33B, a digital TV processing circuit portion 34, a bus interface circuit portion 35, an arbitration circuit 40, etc., which are mounted on, for example, one common board.

The digital TV tuner module (A) 33A receives a digital television broadcast signal, selects a program and demodulates the signal. It includes an RF tuner circuit portion (A) 31A and a digital demodulation circuit portion (A) 32A. An antenna 30A is connected to the RF tuner circuit portion (A) 31A. Similarly, the digital TV tuner module (B) 33B receives a digital television broadcast signal, selects a program and demodulates the signal. It includes an RF tuner circuit portion (B) 31B and a digital demodulation circuit portion (B) 32B. An antenna 30B is connected to the RF tuner circuit portion (B) 31B.

The antenna 30A receives broadcast waves, such as terrestrial digital TV broadcast signals transmitted from broadcast stations, converts them to electric signals, and transmits the electric signals to the RF tuner circuit portion (A) 31A as RF signals. The RF tuner circuit portion (A) 31A performs tuning to a designated channel (selection of a program) based on an RF signal transmitted from the antenna 30A, and transmits the tuned signal to the digital demodulation circuit portion 32A as an intermediate frequency signal (IF signal). The digital demodulation circuit portion (A) 32A performs a signal demodulation process or a correction process based on the IF signal transmitted from the RF tuner circuit portion (A) 31A. It generates a transport stream signal (TS1 signal) in compliance with MPEG2 TS, and outputs the signal under the control of the arbitration circuit 40.

Similarly, the antenna 30B receives broadcast waves, such as terrestrial digital TV broadcast signals transmitted from broadcast stations, converts them to electric signals, and transmits the electric signals to the RF tuner circuit portion (B) 31B as RF signals. The RF tuner circuit portion (B) 31B performs tuning to a designated channel (selection of a program) based on an RF signal transmitted from the antenna 30B, and transmits the tuned signal to the digital demodulation circuit portion 32B as an intermediate frequency signal (IF signal). The digital demodulation circuit portion (B) 32B performs a signal demodulation process or a correction process based on the IF signal transmitted from the RF tuner circuit portion (B) 31B. It generates a transport stream signal (TS2 signal) in compliance with MPEG2 TS, and outputs the signal under the control of the arbitration circuit 40.

The digital TV processing circuit portion 34 receives both the TS1 signal output from the digital TV tuner module (A) 33A and the TS2 signal output from the digital TV tuner module (B) 33B, and performs signal processing including descrambling.

The bus interface circuit portion 35 performs control of transmitting a signal processed by the digital TV processing circuit portion 34 to a PC main logic 110 through the PCI bus. The PC main logic 110 corresponds to data processing functions (including software, such as the playback application 201) realized by the CPU 111 or the main memory 113. The PC main logic 110 can play back or record the signal transmitted from the bus interface circuit portion 35 through the PCI bus.

The arbitration circuit 40 is connected, for example, between the digital demodulation circuit portion (A) 32A and the digital demodulation circuit portion (B) 32B. It can transmit or receive communication information to or from both the digital demodulation circuit portion (A) 32A and the digital demodulation circuit portion (B) 32B. The arbitration circuit 40 arbitrates between the timing of outputting the TS1 signal in the digital demodulation circuit portion (A) 32A and the timing of outputting the TS2 signal in the digital demodulation circuit portion (B) 32B.

More specifically, the arbitration circuit 40 controls signal output operations of the digital demodulation circuit portion (A) 32A and the digital demodulation circuit portion (B) 32B to assure that the TS1 signal and the TS2 signal are alternately transmitted to the digital TV processing circuit portion 34 in synchronism with a predetermined clock in units of packets. In this case, as shown in FIG. 4, the arbitration circuit 40 performs control to alternately transmit the TS1 signal and the TS2 signal at a rate twice that in the case of a conventional apparatus, which continuously transmits packets of the TS1 or TS2 signal. With this adjustment of the rates of alternately transmitting the TS1 signal and the TS2 signal, one of the two digital TV processing circuit portions, which were required in the conventional apparatus, becomes unnecessary without any design change. The TS1 signal and the TS2 signal can be separated from each other by the PC main logic portion 110.

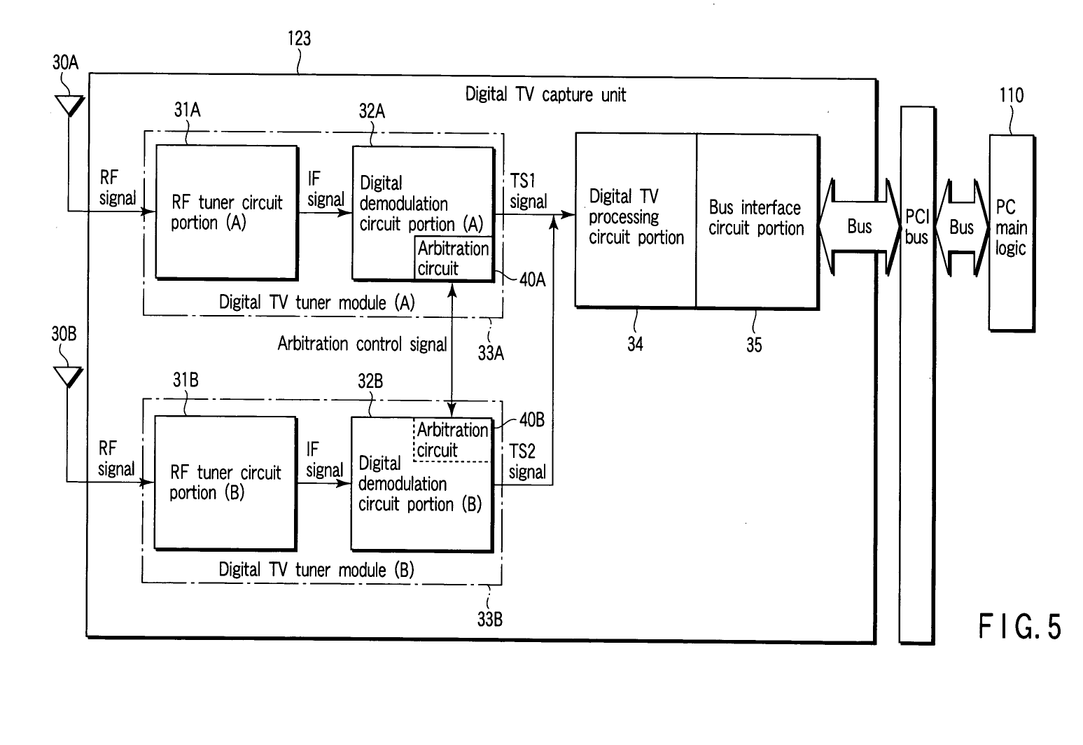

FIG. 5 is a block diagram showing a modification of the configuration of the digital TV capture unit shown in FIG. 3. In the following, structures and operation, which are different from those of the configuration shown in FIG. 3, will be described.

In the configuration shown in FIG. 3, the arbitration circuit 40 is connected between the digital demodulation circuit portion (A) 32A and the digital demodulation circuit portion (B) 32B. In contrast, in the configuration shown in FIG. 5, an arbitration circuit 40A is incorporated in the digital demodulation circuit portion (A) 32A (or an arbitration circuit 40B is incorporated in the digital demodulation circuit portion (A) 32B). With this configuration, the packaging space can be efficiently utilized. The arbitration circuit 40A (or 40B) is configured to transmit/receive control information or the like to/from both the digital demodulation circuit portion (A) 32A and the digital demodulation circuit portion (B) 32B. The other structures and operations are the same as those of the configuration shown in FIG. 3.

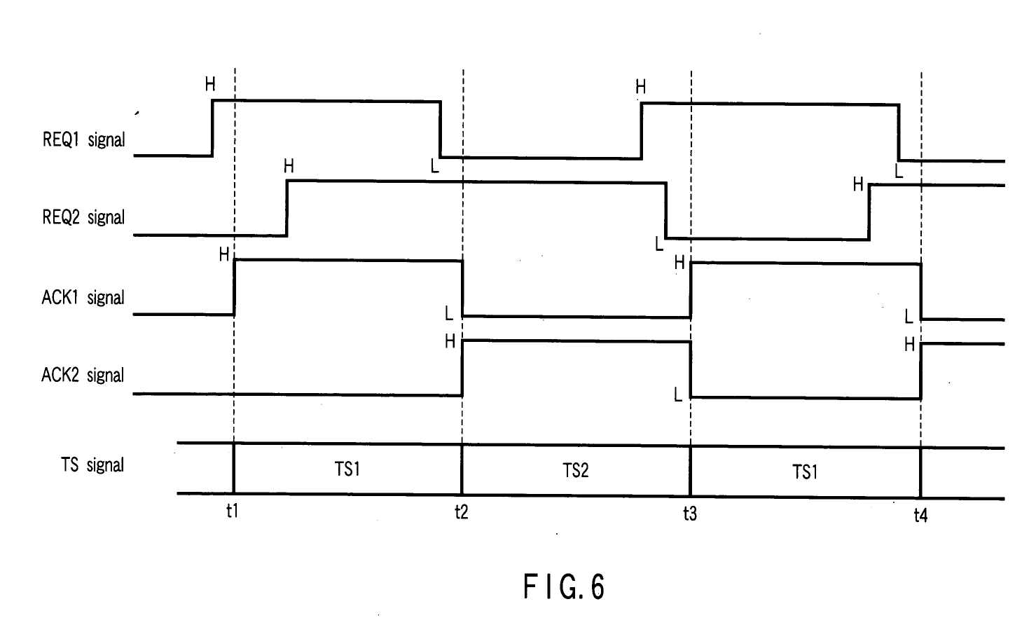

An operation of the arbitration circuit and the like of this embodiment will now be described with reference to the timing chart shown in FIG. 6. In the following, it is assumed that the arbitration circuit 40 shown in FIG. 3 executes an arbitration process.

The digital demodulation circuit portion (A) 32A sets a REQ1 signal to an H level and makes a request for arbitration to the arbitration circuit 40, when it is prepared to output the TS1 signal. In response to the REQ1 signal, the arbitration circuit 40 sets an ACK1 signal to the H level at timing t1, thereby permitting output of the TS1 signal. As a result, the digital demodulation circuit portion (A) 32A enables output of the TS1 signal, and outputs the TS1 signal at a rate twice as high as the standard rate.

Then, the digital demodulation circuit portion (B) 32B sets a REQ2 signal to the H level and makes a request for arbitration to the arbitration circuit 40, when it is prepared to output the TS2 signal. At this time, since the output of the TS1 signal is allowed in response to the REQ1 signal, the TS2 signal cannot be output yet. In other words, the ACK2 signal is at an L level, and output of the TS2 signal is not enabled.

When the transfer of a packet of the TS1 signal has completed, the digital demodulation circuit portion (A) 32A sets the REQ1 signal to the L level and temporarily withdraws the request. Then, the arbitration circuit 40 sets the ACK2 signal to the H level at timing t2 in response to the REQ2 signal of the H level, thereby permitting output of the TS2 signal. At the same time, it sets the ACK1 signal to the L level, thereby prohibiting output of the TS1 signal. Thus, the digital demodulation circuit portion (B) 32B enables output of the TS2 signal, and outputs the TS2 signal at a rate twice as high as the standard rate.

Then, the above processes are repeated.

As described above, according to this embodiment, a packet of the TS1 signal and a packet of the TS2 signal are alternately transmitted to the digital TV processing circuit portion 34 at the rate twice that in the case of a conventional apparatus, which continuously transmits packets of the TS1 or TS2 signal. With this adjustment of the rates of alternately transmitting the TS1 signal and the TS2 signal, one of the two digital TV processing circuit portions, which were required in the conventional apparatus, becomes unnecessary without any design change. Consequently, reduction in size, power consumption and cost of the digital TV capture unit can easily be realized.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A digital TV capture unit electrically connectable to a system bus of a computer, the unit comprising:
a first digital TV tuner module configured to receive a digital television broadcast signal and perform channel selection and signal demodulation;
a second digital TV tuner module configured to receive a digital television broadcast signal and perform channel selection and signal demodulation;
a signal processing circuit configured to receive both a first output signal from the first digital TV tuner module and a second output signal from the second digital TV tuner module, the circuit configured to perform signal processing, including descrambling;
a bus interface circuit configured to perform control of transmitting a signal processed by the signal processing unit; and
an arbitration circuit configured to control signal output operations of the first digital TV tuner module and the second digital TV tuner module to assure that the first output signal and the second output signal are alternatively transmitted to the signal processing circuit in synchronism with a predetermined clock in units of packets.

2. The digital TV capture unit according to claim 1, wherein the arbitration circuit is further configured to perform control to alternately transmit the first output signal and the second output signal at a rate twice that in a case of continuously transmitting packets of the first or second output signal.

3. The digital TV capture unit according to claim 1, wherein the arbitration circuit is connected between the first digital TV tuner module and the second digital TV tuner module.

4. The digital TV capture unit according to claim 1, wherein the arbitration circuit is incorporated within one of the first digital TV tuner module and the second digital TV tuner module.

5. The digital TV capture unit according to claim 1, wherein the first digital TV tuner module, the second digital TV tuner module, the signal processing circuit, the bus interface circuit and the arbitration circuit are mounted on a common board.

6. An information processing apparatus comprising:
a system bus;
a digital TV capture unit connected to the system bus; and
a processing portion configured to play back or record information transmitted from the digital TV capture unit through the system bus,
the digital TV capture unit comprising:
a first digital TV tuner module configured to receive a digital television broadcast signal and perform channel selection and signal demodulation;
a second digital TV tuner module configured to receive a digital television broadcast signal and perform channel selection and signal demodulation;
a signal processing circuit configured to receive both a first output signal from the first digital TV tuner module and a second output signal from the second digital TV tuner module, and perform signal processing including descrambling;
a bus interface circuit configured to perform control of transmitting a signal processed by the signal processing circuit to the system bus; and
an arbitration circuit configured to control signal output operations of the first digital TV tuner module and the second digital TV tuner module to assure that the first output signal and the second output signal are alternately transmitted to the signal processing circuit in synchronism with a predetermined clock in units of packets.

7. The information processing apparatus according to claim 6, wherein the arbitration circuit is further configured to perform control to alternately transmit the first output signal and the second output signal at a rate twice that in a case of continuously transmitting packets of the first or second output signal.

8. The information processing apparatus according to claim 6, wherein the arbitration circuit is connected between the first digital TV tuner module and the second digital TV tuner module.

9. The digital TV capture unit according to claim 6, wherein the arbitration circuit is incorporated within one of the first digital TV tuner module and the second digital TV tuner module.

10. A signal transmission method applied to a digital TV capture unit electrically connectable to a system bus of a computer, the method comprising:
receiving a digital television broad cast signal and performing channel selection and signal demodulation by a first digital TV tuner module;
receiving a digital television broad cast signal and performing channel selection and signal demodulation by a second digital TV tuner module;
controlling signal output operations of the first digital TV tuner module and the second digital TV tuner module to assure that a first output signal from the first digital TB tuner module and the second output signal from the second digital TV tuner module are alternately output in synchronism with a predetermined clock in units of packets;
inputting both the first output signal and the second output signal to a signal processing circuit, and performing signal processing including descrambling; and
performing control of transmitting a signal processed by the signal processing circuit to the system bus by a bus interface circuit.
